(19) United States
(12) Patent Application Publication
(10) Pub. No.: US 2003/0105259 A1
(43) Pub. Date: Jun. 5, 2003

(54) Use of a resin for producing a hot-melt-type adhesive

(76) Inventors: Marcus Heemann, Neuss (DE); Ingo Gensch, Gangelt (DE)

Correspondence Address: HENKEL CORPORATION, 2500 RENAISSANCE BLVD, STE 200, GULPH MILLS, PA, 19406, US

(21) Appl. No.: 10/240,478

(22) PCT Filed: Mar. 30, 2001
(86) PCT No.: PCT/EP01/03628

(30) Foreign Application Priority Data
Apr. 5, 2000 (DE) 10016783.7

(51) Int. Cl. C09F 1/00

(52) U.S. Cl. 527/600

(57) ABSTRACT

An improved hot-melt-type adhesive is improved by including in the hot-melt-type adhesive the reaction product of pine rosin with formaldehyde. The addition of the pine rosin/formaldehyde reaction product improves the separation of the adhesive from the substrate in an alkaline washing bath. The adhesive precipitates as a coarsely dispersed non tacky form and can be easily removed from the washing bath.

This invention relates to the use of a resin for producing a hotmelt adhesive which, after bonding, is removed from the substrates again in an alkaline medium.

One such hotmelt adhesive is already known. Thus, WO 97/01483 describes an adhesive system for bonding wrap-around labels which comprises a pickup adhesive and an overlap adhesive. If the pickup adhesive adheres to the container and not to the label, it should preferably be soluble in an alkaline medium, i.e. it saponifies and dissolves in a 1% sodium hydroxide solution at 50° C. up to a concentration of 10% by weight, preferably in 20 minutes. An alkali-soluble pickup adhesive such as this contains

I 20 to 58% by weight of an alkali-soluble polymer which acts as a backbone polymer,

II 1 to 70% by weight of at least one resin based on functional hydrocarbon resins or optionally modified natural resins,

III 0.5 to 30% by weight of at least one plasticizer and

IV 0 to 3% by weight of at least one typical auxiliary and additive.

The resin is

a) hydroabietyl alcohol and esters thereof, more particularly esters thereof with aromatic carboxylic acids, such as terephthalic acid and phthalic acid,

b) preferably modified natural resins, such as resin acids of gum rosin, liquid rosin or wood rosin, for example fully saponified gum rosin or alkyl esters of optionally partly hydrogenated pine rosin with low softening ranges such as, for example, methyl, diethyleneglycol, glycerol and pentaerythritol esters,

c) acrylic acid copolymers, preferably styrene/acrylic acid copolymers and

d) a resin based on functional hydrocarbon resins. According to Example B), an adhesive such as this takes 2 to 10 minutes to dissolve completely in a 1% sodium hydroxide solution at 80° C. The advantage of this known adhesive is that the plastic containers or parts thereof are obtained free from adhesive after washing with alkali and can be re-used either directly or in the production of new containers. The disadvantage is that the adhesive is dissolved in the wash liquor and is difficult to remove therefrom. Accordingly, large volumes of wash liquors with high soil levels accumulate. Nowadays, these soiled wash liquors are evaluated on the basis of their chemical oxygen demand (COD), the COD level determining the wastewater taxes to be paid.

Against the background of this prior art, the problem addressed by the invention was to provide an adhesive and a process which would enable the adhesive-containing products to be removed or even re-used in a simple, economical and environmentally friendly manner. The adhesive would of course retain its original positive application and performance properties. This would apply in particular to its high adhesive strength and yet easy and complete separation only under certain conditions.

The solution to this problem is defined in the claims and consists essentially in the addition to the hotmelt adhesives of a certain component which

a) effects virtually complete removal of the adhesive from the plastic substrate,

b) much of the adhesive removed accumulating as a nontacky phase in the wash liquor and,

c) providing the adhesive components are suitably selected, the separate adhesive particles floating on the wash liquor.

According to the characterizing feature, the resin component to be used in accordance with the invention is the reaction product of pine rosin and formaldehyde. This is a reaction product obtainable from paraformaldehyde and pine rosin, preferably a) with an acid value of at least 140, more particularly in the range from 150 to 200 and above all in the range from 150 to 160 mg KOH/g (as measured to DIN 53 402) and b) with a softening point of at least 70 and preferably in the range from 75 to82° C. (as measured to DIN 52 011). The tendency towards crystallization is minimal, preferably with no evidence of crystallization after 72 hours at room temperature.

Pine rosin is a natural resin which is obtained from the crude resins of conifers either as a distillation residue of turpentine oil (=gum rosin), as a distillation residue of tall oil (=liquid rosin) or as an extract of conifer root stocks (=wood rosin). A gum rosin with formaldehyde or paraformaldehyde is preferably used.

The quantity of the pine rosin/formaldehyde reaction product in the hotmelt adhesive should be in the range from 1 to 80% by weight and preferably in the range from 25 to 55% by weight, based on the hotmelt adhesive as a whole, to achieve rapid removal of the adhesive film from the plastic surface. Factors influencing removal include the plastic surface, the composition of the adhesive and the washing conditions. The particular quantity required can be determined by a few simple tests (see Examples).

Besides this “release agent”, all the components typically encountered in hotmelt adhesives for the particular purpose are present, i.e. basic hotmelt constituents, plasticizers, waxes, resins, fillers and auxiliaries, such as stabilizers, antioxidants and dyes.

Basic hotmelt constituents are understood to be thermoplastic synthetic polymers which largely determine important properties for the hotmelt adhesives, such as adhesion, strength and temperature behavior (=backbone polymers). Such polymers are:

polycondensates, such as polyamide resins, copolyamides, polyamide/EVA copolymers, polyamide/siloxane copolymers, polyether amides, polyester amide imides, polyether ester amides, polyester amides and copolyesters,

polyadducts, such as reactive and nonreactive linear or lightly branched thermoplastic polyurethanes, and

polymers, such as ethylene/vinyl acetate, ethylene/CO, ethylene/vinyl acetate/CO, ethylene/acrylate/CO, propylene/hexene, SIS and SBS copolymers and other thermoplastic elastomers and amorphous polyolefins, metallocen-catalyzed polyolefins, more particularly PP, and finally polybutene.

Preferred polymers are atactic polypropylene, polyamides, polyesters, thermoplastic elastomers and ethylene/vinyl acetate copolymers. The quantity in which the basic hotmelt constituent is present may vary between 0 and 30% by weight and more particularly between 10 and 30% by weight, based on the hotmelt adhesive as a whole.

The plasticizer is present in the hotmelt adhesive in a quantity of generally 0 to 30% by weight and preferably 5 to 30% by weight. Useful plasticizers are mono- or polyhydric alcohols, preferably glycol monophenyl ether, hexamethylene glycol, glycerol and in particular polyalkylene glycols with a molecular weight of 200 to 6,000. Polyethylene glycols with a molecular weight of up to about 1,000 and preferably up to about 600 are preferred. Polypropylene glycol and polybutylene glycol and polymethylene glycol are also suitable. Other suitable plasticizers are esters, for example liquid polyesters and glycerol esters, such as glycerol diacetate and glycerol triacetate, and neopentyl glycol dibenzoate, glyceryl tribenzoate, pentaerythritol tetrabenzoate and 1,4-cyclohexane dimethanol dibenzoate. Finally, alkyl monoamines and fatty acids preferably containing 8 to 36 carbon atoms may also be used. In their case, however, there is a risk of alkali solubility. Accordingly, the above plasticizers are preferably used in low concentrations.

Plasticizers based on aromatic dicarboxylic acid esters, i.e. the corresponding esters of phthalic acid, isophthalic acid or terephthalic acid, are preferably used. The alcohol component in these esters used as plasticizers typically contains 1 to 8 carbon atoms. Medicinal white oil and naphthenic mineral oil are particularly suitable.

Another potential component is at least one natural, chemically modified or synthetic wax. Any waxes compatible above all with amorphous poly-α-olefins may be used. Suitable natural waxes are vegetable waxes, animal waxes, mineral waxes or petrochemical waxes. Suitable chemically modified waxes are hard waxes, such as montan ester waxes, sasol waxes, etc. The synthetic waxes may be selected from polyalkylene waxes and polyethylene glycol waxes. Petrochemical waxes, such as petrolatum, paraffin waxes, microwaxes and synthetic waxes, more particularly polyethylene waxes with melting points in the range from 85 to 140° C. and molecular weights in the range from 500 to 3,500, paraffin waxes with melting points in the range from 45 to 70° C. and molecular weights in the range from 225 to 500, microcrystalline waxes with melting points in the range from 60 to 95° C. and synthetic Fischer-Tropsch waxes with melting points in the range from 100 to 115° C. are preferably used on economic grounds. The quantity of waxes in the hotmelt adhesive is generally in the range from 0 to 30% by weight and preferably in the range from 0 to 10% by weight.

Besides the characterizing resin, the hotmelt adhesive may contain other resins which tackify the backbone polymer and improve the compatibility of the hotmelt adhesive components. This additional resin is generally used in a quantity of up to 50% by weight and preferably in a quantity of 5 to 30% by weight and is selected from

a) hydroabietyl alcohol and esters thereof, more particularly esters thereof with aromatic carboxylic acids, such as terephthalic acid and phthalic acid,

b) preferably modified natural resins, such as resin acids of gum rosin, liquid rosin or wood rosin, for example fully saponified gum rosin or alkyl esters of optionally partly hydrogenated pine rosin with low softening ranges such as, for example, methyl, diethyleneglycol, glycerol and pentaerythritol esters,

c) acrylic acid copolymers, preferably styrene/acrylic acid copolymers and

d) a resin based on functional hydrocarbon resins.

An alkyl ester of partly hydrogenated pine rosin, the alkyl group preferably containing 1 to 6 carbon atoms, may also be used as the tackifying resin.

Partially polymerized liquid rosin, hydrogenated hydrocarbon resin and pine rosin glycerol ester are preferably used.

The fillers may be used to reduce the cost of the hotmelt adhesive although they are preferably intended to improve its performance, adhesive and reprocessing properties. The fillers used are solid, nonvolatile, inert materials, above all chalk. Their percentage content in the hotmelt adhesive is preferably in the range from 0 to 30% by weight.

In addition, typical auxiliaries and additives may be incorporated in the hotmelt adhesive. Of these, stabilizers are mentioned first and foremost. Their function is to prevent the reactive monomers from reacting undesirably or prematurely and to protect the polymers against decomposition during processing. Antioxidants are particularly mentioned in this regard. They are added to the hotmelt adhesive in quantities of normally up to 2% by weight and preferably between about 0.1 and 1.0% by weight. Other auxiliaries and additives are pigments, more particularly TiO₂.

According to the invention, the above components are used in a composition which befits their use for bonding substrates by application as a melt and by setting on cooling to room temperature (=hotmelt adhesive). The composition is generally solid in consistency at 20° C. and free from solvents that would be problematical during application from the melt.

The composition usable as a hotmelt adhesive in accordance with the use according to the invention generally contains the following components:

A) 1 to 80, preferably 25 to 55% by weight of a pine rosin/formaldehyde reaction product,

B) 0 to 30, preferably 10 to 30% by weight of at least one basic hotmelt constituent,

C) 0 to 30, preferably 5 to 30% by weight of at least one plasticizer,

D) 0 to 30, preferably 0 to 10% by weight of at least one wax,

E) 0 to 50, preferably 5 to 30% by weight of at least one resin other than component A),

F) 0 to 30% by weight of at least one filler and

G) 0 to 2, preferably 0.1 to 1.0% by weight of at least one stabilizer, antioxidant or other auxiliaries,

the sum of the components being 100% by weight.

Hotmelt adhesives with a density of less than 1.0 g/cm³ as measured to DIN 52 004 are preferably used for the process according to the invention. The following components in particular are used for their production, above all in the following quantities:

1 to 30% by weight of the basic hotmelt constituents SIS, SBS and/or EVA,

1 to 20% by weight of the plasticizer medicinal white oil,

1 to 20% by weight of the wax PE wax and

1 to 3% by weight of the resin pine rosin glycerol ester or hydrocarbon resin.

Another preferred embodiment is characterized by the use of hotmelt adhesives of which less than 50, more particularly less than 30 and above all less than 20% by weight dissolves in a 2% NaOH solution at 65° C. in the form of a 300 μm and more particularly 100 μm thick film after stirring for 10 minutes with a laboratory stirrer. The hotmelt adhesives of this embodiment are preferably produced from the following components in the quantities shown:

1 to 30% by weight of the basic hotmelt constituents SIS, SBS and/or EVA,

1 to 30% by weight of the plasticizer med. white oil,

1 to 20% by weight of the wax paraffin wax,

20 to 30% by weight of the resin hydrocarbon resin and

1 to 20% by weight of the filler based on a copolyester.

Despite the sometimes high content of the characterizing resin, hotmelt adhesives with the hitherto known properties can still be produced. Thus, pressure-sensitive or non-pressure-sensitive, non-blocking or granulatable adhesive compositions are obtained according to the type and quantity of components used. They may have low and high viscosities, i.e. their viscosity is in the range from 0.1 to 100 Pas or in the range from 0.3 to 2 Pas at 150° C., as measured to ASTM D 3236-88. Above all, their viscosity is stable even at high temperatures. It changes by less than 20% after 24 hours at 160° C., as measured to ASTM D 3236-88. Overall aging resistance is good, i.e. color and viscosity are stable within the typical limits for hotmelt adhesives.

Despite the characterizing resin, low-migration hotmelt adhesives can be also be produced, i.e. in the bonding of paper and at high storage temperatures (50-60° C.), constituents of the adhesive do not strike through the paper. Flexibility is sufficient to follow the change in volume of a PET bottle filled with CO₂-containing beverages.

The compositions to be used in accordance with the invention are generally prepared by mixing the components. To this end, the plasticizers, waxes and resins are first mixed at 120 to 180° C. and more particularly at around 160° C to form a homogeneous melt. The pine rosin/formaldehyde reaction product, then the filler and finally the basic hotmelt constituent are added. The whole is then stirred to homogeneity. After the fully homogenized composition has been introduced into suitable containers, it is left to cool, solidifying in the process. It is now ready to use. The melt could of course also be directly applied to a substrate without cooling and could thus be directly used for bonding without intermediate cooling. However, the hotmelt adhesive to be used in accordance with the invention, in the same way as other commercially available hotmelts, is normally melted before use and then applied to the substrate to be bonded. It is distinguished by good machine compatibility properties, i.e. shows minimal soiling and high reliability, even in high-speed machines.

The hotmelt adhesives to be used in accordance with the invention are used for the bonding of substrates of which at least one is to be recycled. The materials in question are glass, varnished or unvarnished paper or corresponding paperboards and, above all, plastics, for example PET, PEN, PP, PVC, PS and PE. Containers or films, for example, can be produced from such materials.

The substrates to be bonded in the context of the present invention are, in particular, containers on the one hand and labels on the other hand, more particularly plastic or paper labels bonded to PET bottles.

Actual examples of containers are bottles, cans, casks, tubes or cartridges. They consist essentially of optionally plated or electroplated metal (for example tin plate or aluminium), glass or thermoplastics, such as polyethylene terephthalate,- polycarbonate, polyethylene, polypropylene, polyvinyl chloride or polystyrene. A polar plastic, more particularly a polyester, is preferred. Containers such as these are used in particular for mineral waters and refreshing drinks.

The labels consist on the one hand of thermoplastics, such as polyethylene, polypropylene, polystyrene, polyvinyl chloride or cellophane. It is preferred to use labels of a film based on nonpolar plastics, more particularly oriented polypropylene (OPP). In this case, a hotmelt adhesive based on poly-α-olefin is preferably used. However, the labels may also be based on paper, optionally in combination with a polymer. Depending on the material and the production process, the following labels, for example, may be used: simple labels of unrefined paper, labels of refined paper, high-gloss labels of cast coated label papers, labels of aluminized papers and labels of aluminium-lined papers.

The shape of the labels does not have to meet particular requirements. For example, the labels may be wrap-around labels and shield labels.

Accordingly, the invention is used quite generally for bonding applications where at least one substrate has a plastic surface, more particularly in the packaging industry, for example for labelling, for the sealing of boxes and for bookbinding.

The effect of the characterizing resin is essentially that it guarantees separation from the useful material to be recycled in the alkaline medium (preferably 1 to 2% NaOH or KOH solution). In addition, the adhesive thus produced is distinguished by the fact that even pressure-sensitive adhesive compositions become nontacky in the alkaline medium and do not collect on the useful material or on the corresponding equipment.

The hotmelt adhesive is preferably removed from the substrate by treatment in an alkaline medium with a pH of at least 9 and preferably 12 at 20 to 95° C. and preferably at 60 to 80° C.

A particular application of the use according to the invention is the recycling of disposable PET bottles. Where high-quality recycled PET was to be obtained, it was necessary in the past to sort out containers labelled with hotmelt adhesives and to subject them to a laborious, energy-intensive washing process. Wash liquor concentrations of 2% and temperatures of 90° C. were commonplace. The contact time could be as long as 20 minutes. By virtue of the process according to the invention, the contact time can be reduced to 10 minutes, the wash liquor concentration to 1% and the washing temperature to 60° C. With longer contact times, wash liquor temperatures of <60° C. are even possible. However, the process according to the invention not only creates more moderate washing conditions, it also provides high-quality recycled PET which can be used for new bottles in larger quantities than otherwise usual (>10%).

Good separation from the useful materials in the alkaline medium is achieved by the use of the characterizing resin. In addition, the adhesive is prevented from collecting on the useful material and in the recycling equipment. The choice of the backbone polymers provides for high cohesion which prevents the adhesive from being dispersed in the wash liquor. Instead, it separates in the form of relatively large particles. If a density below the density of the wash liquor is obtained through suitable combinations of raw materials, the adhesive residues float to the surface of the wash liquor and can thus be separated from the sinking PET granules. Depending on the formulation of the adhesive, a large part of the adhesive floats to the surface, the smaller part (always less than 30%) being dispersed or dissolved.

The particular advantages of the invention lie in the relatively low raw material costs, particularly in comparison with fully alkali-soluble hotmelt adhesives. In addition, the largest part of the adhesives does not contaminate the wash liquor and can be removed by suitable methods (for example centrifuging or flotation). In addition, better qualities of the recycled material can be obtained.

The invention is illustrated by the following Examples.

### EXAMPLES

I Production and properties of the hotmelt adhesives

1. Starting components

a) pine rosin/formaldehyde reaction product, “Resitherm CA 70/30 N”, A product of SOCER, Lisbon

b) ethylene/vinyl acetate copolymer “ALCUDIA PA 443”, a product of REPSOL

c) styrene/isoprene/styrene block copolymer “VECTOR 4111” a product of Exxon Chemical

d) styrene/butadiene/styrene block copolymer “VECTOR 4461-D”, a product of Exxon Chemical

e) copolyester: branched sulfopolyester “AQ 1045”, a product of Eastman

f) pine rosin glycerol ester “Sylvatac RE 85”, a product of Arizona Chemical

g) hydrogenated hydrocarbon resin “Regalite R 7100-S”, a product of Hercules

h) partly polymerized liquid rosin “Sylvatac-PR-R-85”, a product of Arizona Chemical

i) naphthenic mineral oil “Shell Oil 4178”, a product of Shell, kinematic viscosity 551 mm²/s at 20° C. (to DIN 51562)

j) medicinal white oil FDA-CFR 172.36020-B “PIONIER 0352 T”, a product of Hansen & Rosenthal, viscosity 220 mm²/s at 20° C. (to DIN 51562)

k) polyethylene wax: low molecular weight ethylene/vinyl acetate copolymer “LE-Wachs 334”, a product of Leuna-Werke AG, melt viscosity 300-500 mm²/s at 140° C. to DIN 51550, Vac content 10-12% by weight

l) paraffin wax “Petrolite C 4040”, a product of Exxon

m) stabilizers (antioxidant and heat stabilizer) “Irganox 1010”and “Irganox PS 800”, products of Ciba-Geigy

2. Composition in % by weight

| | Example | | | |
|---|---|---|---|---|
| Components | 1 | 2 | 3 | 4 |
| Ethylene/vinyl acetate copolymer | | 25 | | 5.0 |
| Styrene/isoprene/styrene block copolymer | 9 | | 10.0 | 10.0 |
| Styrene/butadiene/styrene block copolymer | 8 | | 10.0 | |
| Copolyester | 6 | | 6.0 | |
| Pine rosin/formaldehyde reaction product | 40.9 | 50.9 | 30.9 | 38.9 |
| Pine rosin glycerol ester | 10.0 | 18.5 | | |
| Hydrogenated hydrocarbon resin | | | 28.1 | |
| Partly polymerized liquid rosin | | | | 17.6 |
| Naphthenic mineral oil | | 5 | 11.0 | 21.0 |
| Medicinal white oil (DAB) | 24.0 | | | |
| Polyethylene wax | 1.5 | | 3.5 | 1.5 |
| Petroleum wax | | | | 6.0 |
| 2,2′-Thiodipropionic acid dilauryl ester | 0.3 | 0.3 | | |
| Pentaerythritol tetrakis-C3-(3,5-di-tert.butyl- | 0.3 | 0.3 | 0.5 | |
| 4-hydroxyphenyl)-propionate | | | | |
| Total | 100 | 100 | 100 | 100 |

3. Production of the hotmelt adhesives by mixing

The plasticizers, waxes and resins are first mixed at 160° C. in a laboratory mixer until they appear (optically) uniform (homogeneous) to the eye. The pine rosin/formaldehyde reaction product and finally the polymers are then added and again completely homogenized. This generally takes a total of ca. 60 to 120 mins. Depending on the composition, the melt is transparent, opaque or cloudy (the same applies to the melt cooled to room temperature).

The melt mixture is introduced into containers and then cooled, solidifying in the process. After cooling, it is used for various purposes according to its composition.

4. Description of the hotmelt adhesives

### Example 1

Pressure-sensitive low-viscosity hotmelt adhesive which may mainly be used for labelling plastic containers with paper labels.

### Example 2

Non-pressure-sensitive, granulatable hotmelt adhesive which is particularly suitable for bonding highly varnished paperboards and papers.

### Example 3

High-viscosity hotmelt adhesive for coating films.

### Example 4

Pressure-sensitive hotmelt adhesive which is particularly suitable for labelling plastic containers with plastic labels.

All the hotmelt adhesives are separated from their substrates in the alkaline medium and, by virtue of their coarse-particle form, are easy to remove from the wash liquor.

II Use of the hotmelt adhesives

1. Labelling

In a Krones “Conti Roll” test labelling unit, the hotmelt adhesive of Examples 1 and 4 was applied in strips by roller to the beginning and end of OPP labels in a quantity of 1.1 g/m² (corresponding to a quantity of 0.05 g/label) at a temperature of 140° C. PET bottles were then labelled.

2. Recycling

The bottles were size-reduced to ca. 1×1 cm pieces of which 20 g were introduced into 500 ml of a liquor of 2 g NaOH (and optionally defoamer, surfactants, corrosion inhibitors) in 100 ml water at 80° C., followed by 10 minutes' stirring with a commercially available magnetic laboratory stirrer at a speed of ca. 400 r.p.m. In every case, the adhesive separated from the PET and dispersed to particles a few mm in size—depending on the adhesive—which did not stick to one another or to the equipment. The nontacky particles floated on the wash liquor and were easy to skim off. After the particles skimmed off had dried, the following figures—based on the amount of adhesive weighed in—were obtained for Example 1 by weighing out:

70% by weight float to the surface,

30% by weight do not float to the surface, but are finely dispersed or dissolved and

distinctly less than 10% by weight had dissolved.

In production, the PET recycling process takes place substantially as follows:

The PET bottles are supplied with labels and tops and are presorted by hand. Depending on the quality to be produced, large PET bottles with a low residual content are presorted for high PET qualities and small PET bottles with a high residual content are presorted for low PET qualities. In addition, the bottles can be sorted by color. The bottles are washed in cold water, after which foreign constituents are sorted out by hand. Bottles, labels and tops are then size-reduced and then re-washed for 500 seconds. This washing process is determined by the quality required. For relatively low qualities, cold water or warm water only is used for washing; for high quantities, water with additives heated to 80-90° C. is used for washing. The additives used are 2% Oakite RC 83 E (Oakite Europe GmbH, Trakehner Str., Frankfurt/Main) and defoamer (<50% KOH). The pH of the wash liquor is ca. 10-11. After the washing process, foreign matter (tops, labels, etc.) is removed by flotation and separators. The washed and dried PET is then extruded and granulated.

An adhesive which separates completely from the PET bottle in cold water and floats to the surface with other foreign matter would be optimal for recycling. Unfortunately, this is at variance with the need for high resistance of the labelled bottles to condensation water.

3. Laboratory recycling test

The following test was carried out in order to classify adhesives for the recycling process in practice:

1. A 2×8 cm PET film is washed in cold water, dried for 2 hours at 105° C. and then weighed (weight W1).

2. 0.5 g adhesive is applied in a layer thickness of 200 μm, dried for 2 hours at 51° C. and then weighed (weight W2).

3. The PET film with the adhesive is immersed with stirring for 2 mins. in water heated to 90° C., cooled for 3 mins. with cold water, immersed with stirring for 10 mins. in a wash liquor with a pH of 12.8 (adjusted with Oakite RC 93) and a temperature of 65° C., immersed with stirring for 3 mins. in cold water, dried for 2 hours at 60° C. and finally weighed (weight W3).

The removability (A in %) of the adhesive is calculated on the basis of the following equation: (W2-W3)/(W2-W1). A removability of less than 60% rates as unacceptable, a removability of 60 to 90% as acceptable and a removability of more than 90% as good.

Removabilities of more than 99% were obtained for Examples 1 to 4.

1. The use of a resin for the production of a hotmelt adhesive which, after bonding, is removed from the substrates again in an alkaline medium, characterized in that a pine rosin/formaldehyde reaction product is used as the resin.

2. The use claimed in claim 1, characterized in that the hotmelt adhesive contains the following components:
A) 1 to 80% by weight of a pine rosin/formaldehyde reaction product,
B) 0 to 30% by weight of at least one basic hotmelt constituent,
C) 0 to 30% by weight of at least one plasticizer,
D) 0 to 30% by weight of at least one wax,
E) 0 to 50% by weight of at least one resin other than component a),
F) 0 to 30% by weight of at least one filler and
G) 0 to 2% by weight of at least one stabilizer, antioxidant or other auxiliaries,
the sum of the components being 100% by weight:

3. The use claimed in claim 2, characterized in that the hotmelt adhesive contains the following components:
A) 25 to 55% by weight of a pine rosin/formaldehyde reaction product,
B) 10 to 30% by weight of at least one basic hotmelt constituent,
C) 5 to 30% by weight of at least one plasticizer,
D) 0 to 10% by weight of at least one wax,
E) 5 to 30% by weight of at least one resin other than component A),
F) 0 to 30% by weight of at least one filler and
G) 0.1 to 1.0% by weight of at least one stabilizer, antioxidant or other auxiliary,
the sum of the components being 100% by weight.

4. The use claimed in claim 2 or 3, characterized in that the hotmelt adhesive has a density of less than 1.0 g/cm³ and, besides the pine rosin/formaldehyde reaction product, contains in particular the following components:
SIS, SBS and/or EVA as the basic hotmelt constituent,
medicinal white oil as the plasticizer,
polyethylene wax as the wax and
hydrogenated hydrocarbon resin or pine rosin glycerol ester as the resin.

5. The use claimed in claim 2 or 3, characterized in that less than 50, more particularly less than 30 and above all less than 20% by weight of the hotmelt adhesive dissolves in a 2% NaOH solution at 65° C. in the form of a <300 μm thick film after stirring for 10 mins. with a laboratory magnetic stirrer.

6. The use claimed in claim 5, characterized in that, besides the pine rosin/formaldehyde reaction product, the hotmelt adhesive contains in particular the following components:
SIS, SBS and/or EVA as the basic hotmelt constituent,
medicinal white oil as the plasticizer,
paraffin wax as the wax,
hydrocarbon resin as the resin and
a copolyester as the filler.

7. The use claimed in claim 6, characterized by the following production process for the hotmelt adhesive:
1. mixing of plasticizers, waxes and resins at ca. 160° C. to form a homogeneous melt,
2. addition with stirring of the pine rosin/formaldehyde reaction product, the fillers and finally the basic hotmelt constituents to homogeneity.

8. The use claimed in claim 1, characterized by bonding where at least one substrate has a plastic surface, more particularly the bonding of labels, box closures and books.

9. The use claimed in claim 8, characterized by bonding of plastic or paper labels to PET bottles.

10. The use claimed in claim 1, characterized by removal of the hotmelt adhesive from the substrate by a treatment in an alkaline medium with a pH of at least 9 and preferably 12 at 20 to 95° C. and preferably at 60 to 80° C.
